(19) United States
(12) Patent Application Publication
(10) Pub. No.: US 2015/0264744 A1
(43) Pub. Date: Sep. 17, 2015

(54) THERMALLY CONTROLLED SHIPPING CONTAINER

(71) Applicants: JAMES ROXBOROUGH CHOPPING, ELK CITY, OK (US); ROLAND RAYMOND SORELLE, JR., ELK CITY, OK (US)

(72) Inventors: JAMES ROXBOROUGH CHOPPING, ELK CITY, OK (US); ROLAND RAYMOND SORELLE, JR., ELK CITY, OK (US)

(21) Appl. No.: 14/204,095

(22) Filed: Mar. 11, 2014

(51) Int. Cl. H05B 1/02; G05D 23/19

(52) U.S. Cl. CPC H05B 1/023; G05D 23/19

(57) ABSTRACT

A device for thermally controlling, preserving and safely transporting specimens and method includes a housing and sub compartment therein which includes both heating and cooling elements and employs a microprocessor for controlling rate of descending or ascending temperature.

### FILED OF INVENTION

The present invention generally relates to shipping containers, and more specifically to temperature controlled containers for shipping biologic and other temperature-sensitive materials using thermal elements to affect the interior temperature. More specifically, this invention relates to a method and device for cooling, preserving and safely transporting biological material such as semen specimens and particularly to such methods and devices that provide an optimum cooling rate and optimum steady state temperature for the cooled specimen which is subject to removal and inspection in todays shipping environment.

### PRIOR ART

There exist many prior thermally controlled shipping containers to attempt to maintain temperature at a specific temperature or within a range. Artificial insemination has been used in many fields for breeding. Previously, animal semen could be put into condition for preservation for relatively long periods of time and was able to be maintained in a specific temperature condition during transportation. As a result, it was relatively easy to provide such specimens for use at locations distant in time or place from the location where the specimen was originally obtained.

However, with the increased security checks and advent of TSA, it has become increasingly difficult to transport such specimens without the same becoming compromised by relatively radical changes in temperature. Some semen is more sensitive to changes in temperature, thermal shock and freezing during transportation. Such changes in temperature greatly decreases potency. The post-warmup potency of semen depends strongly on the rate that it is cooled to achieve even the short term preservation of efficacy. Too rapid a temperature decrease can result in thermal shock to the spermatozoa. Too slow a temperature change leaves the spermatozoa at high temperature for too long, causing decreased viability.

Many of the devices and methods used for preserving and transporting other kinds of biological material are no longer suitable for semen transport. Such devices and methods do not take into account the rigors of todays security checks and potential for changed temperature environment.

Some examples of prior techniques are described. U.S. Pat. No. 4,947,658, by Wheeler, et. al., teaches the use of a vessel filled with a frozen substance and a nonfrozen substance, which frozen substance is used to keep the nonfrozen substance cool, as well as act as a heat sink to help keep frozen a second frozen substance. The vessel consists of an insulated chest with four walls a bottom and an open top with a space for a refrigerant material below a shelf support. The shelf support supports an insulated shelf which shelf is used to control the heat transfer between the frozen refrigerant and the unfrozen material which is stored on the shelf. The shelf is of course removable to allow access to the refrigerant material and the frozen substances shipped with it. It is intended for ordinary cold, as opposed to cryogenic, temperatures.

U.S. Pat. No. 4,576,017, issued to Combs, et. al. (1986), teaches the use of an insulated vessel containing a heat exchange medium used in conjunction with an open space to allow convection currents to keep a frozen material at a substantially constant temperature. The system does not utilize a heat sink or other thermal storage means, thus the retention time at a given temperature is limited by the thermal mass of the stored material and by the efficiency of the insulation. Sexton, in U.S. Pat. No. 4,955,480, (1990) teaches the use of a box made of expanded polystyrene foam containing a plastic container which holds a frozen liquid, which frozen liquid is in turn hollow and in which pharmaceutical solutions are placed for shipment. The polystyrene foam, with an average thermal conductivity in the range of 0.033 Watts/meter degree K., (compared to a Dewar flask with an effective conductivity about 100 times lower) is not very effective as a cryogenic insulator, but the Sexton invention is concerned with shipment of materials in the range of 0 to 4 degrees C.

Ammerman, in U.S. Pat. No. 4,723,974, (1988) teaches of a flexible double wall container, between the walls of which is placed a pair of separately packaged materials which cool when their packages are ruptured and they are allowed to mix. The inner container is meant to be used for shipping amputated extremities.

U.S. Pat. No. 4,502,295, issued to Toledo-Pereyra, (1985) teaches the use of a container made of plastic, having a plurality of receptacles and containing an inner container filled with ice in a manner similar to the previously cited method of Wheeler et. al. and having a drain to allow melted icewater to run out. The container must be kept vertical so that the water can drain out as the ice melts, thus maintaining a uniform internal temperature. The receptacles are intended for constant-temperature shipment of organs at a temperature between 0 degrees and 7 degrees C. during shipment. U.S. Pat. No. 4,951,482, by Gilbert (1990), uses a double walled container for shipping organs. A means is included for circulating an externally chilled refrigeration fluid between the walls.

Swenson and Koski, in U.S. Pat. No. 3,406,531, (1968) use a similar system in which organs are kept at a constant temperature between 0 degrees and 4 degrees C. by circulating a refrigerant liquid between the container and a refrigerant system. An external refrigerator system is required for this system. Peterson, in U.S. Pat. No. 3,810,367, (1974) illustrates the use of a double walled insulated vessel with a mixture of ice and water between the walls, to ship human organs at a constant 32 degree F. temperature.

Douglas-Hamilton, in U.S. Pat. No. 4,530,816, (1988) teaches the use of ice in an insulated vessel, which ice is separated from a biological material by a sheet of insulating material, similar in manner to the previously cited methods of Wheeler et. al. and of Toledo-Pereyra. The insulating layer is used to maintain the chilled specimen in a temperature range just above freezing for storage and/or transport. The thickness of the insulating layer between the ice and the stored material is selected so as to impart an optimum heat extraction rate to the specimen in order to result in a steady-state temperature just above freezing for shipment. This cooling control and above-zero storage is necessary to optimize the post-thaw motility rate in the case of equine semen. Vertical orientation is required during shipment and storage to keep the ice on the bottom.

Guilhem and Wengler, U.S. Pat. No. 4,958,506 (1990) (French appin. no. 88 02845), teach of an insulated container having two compartments, a lower one filled with a mixture of ice and water, and an upper one filled with water and a biological component such as an organ to be transplanted. A heat transfer means such as a heat pipe is used to transfer heat from the upper to the lower compartment so as to maintain the temperature just above freezing during transportation.

All the immediately preceding nine patents are intended for storage and/or shipment at temperatures below the normal ambient, but well above the cryogenic (below zero Celsius) temperatures required for storage and shipment of bovine semen and embryos and human blood.

Loucks, in U.S. Pat. No. 4,292,817 (1981), teaches the use of an insulated container holding liquid filled members for conductive heat transfer between a temperature control means and the interior of the vessel. This method requires the use of an external refrigeration means. Guilbert, in U.S. Pat. No. 4,473,637, (1984) teaches of an insulated shipping box containing a powered refrigeration unit for purpose of shipping organs. Both of these inventions could be adapted for cryogenic use, but both have the disadvantage of requiring an externally powered refrigeration unit attached to or in conjunction with the storage device.

### SUMMARY OF INVENTION

It is therefore an object to provide methods and devices for reliably preserving and safely transporting semen in today's shipping environment wherein specimens are subject to large temperature changes.

It is also an object to provide a method and device handling temperature changes and repeated cooling of semen during a single transport in a controlled manner.

It is a further object to provide for achieving a steady state temperature for the cooled down specimen that is an optimum temperature for preservation of its efficacy.

It is a further object of the invention to provide a method for protection against thermal shock that can decrease semen potency during its transportation.

Finally, it is an object of the invention to provide methods and devices for preserving and transporting semen that are inexpensive to manufacture from commonly available components and that are easy to use.

The invention is also useful for the cooling, preservation and storage of semen, and other biological materials.

Accordingly, one aspect of the invention is directed to a device of the invention, for thermally controlling, preserving and safely transporting specimens. The device includes a container having an inner compartment for containing the specimen within a specimen compartment within the container, which is introduced to the inner compartment at body temperature shortly after it is obtained. The inner compartment can further include an insulated chamber to house the specimen therein.

The container can be of a thermally insulating material for thermally insulating the specimen contained therein from the ambient temperature surrounding the container. One or more cooling member is disposed within the container adjacent and in spaced relation to the inner compartment. The cooling member can include one or more ice or gel packs, for example. The cooling member(s) is configured to cool the specimen in the inner compartment below a desired predetermined shipping temperature, or below the optimum temperature for preserving the viability of the specimen.

The device further includes a heating member, such as a resistor, operably disposed within the inner compartment for applying heat within the specimen compartment to raise and maintain temperature at the desired shipping temperature. A temperature sensor is operably disposed within the inner compartment for sensing the temperature of the specimen. Another temperature sensor can be operably disposed within the container for sensing the temperature of the cooling member.

A controller is operably connected to the temperature sensor and the heating member and can include one or more diagnostic LED connected thereto. Such LEDs can include an error LED, temperature indicator LED, cooling temperature LED. The controller can include for example, a microprocessor having memory and software for obtaining the sensed temperatures and repeatedly controlling the rate of cooling of the specimen once a variation has occurred. A power source, such as a battery, is operably connected to the microprocessor for enabling operation of the microprocessor and controlling operation of the resistor and LEDs.

Temperatures outside the shipping container can typically vary from −10° C. to 40° C. The cooling member would preferably cool to 0° C. Temperature can be elevated and maintained by employing the heating member to maintain a predetermined temperature around 5° C., e.g. Accordingly, the instant invention provides for shipping chilled semen.

The invention enables a rate of cooling of the specimen is an optimum rate. The invention brings the specimen to the desired shipping temperature, e.g. 5° C. at a controlled rate. Once temperature reaches about 18 degrees, the rate of cooling is about one degree Centigrade every 20 minutes, for example. If it gets too cold to quick, the specimen will be jeopardized. The rate of heating to bring the specimen to the desired temperature can also be controlled.

The method of the invention, for cooling, preserving and safely transporting a specimen, includes the steps of providing an insulating container, providing in the container at least one cooling member, at a temperature below the optimum temperature for preserving the viability of the specimen, providing into an inner compartment in the container a specimen container for receiving a specimen at body temperature, providing a heating member within the inner compartment to enable heat to the specimen and providing a processor for controlling application of heat to the specimen to maintain temperature of the specimen at the optimum temperature for preserving the viability of the specimen.

Other objects, features and advantages of the invention will be apparent from, or will be set forth in, the following description of preferred embodiments of the invention, including the drawing thereof.

### BRIEF DESCRIPTION OF THE DRAWINGS

FIG. 1 is a perspective diagram view of the invention;

FIG. 2 is a schematic diagram of the invention; and

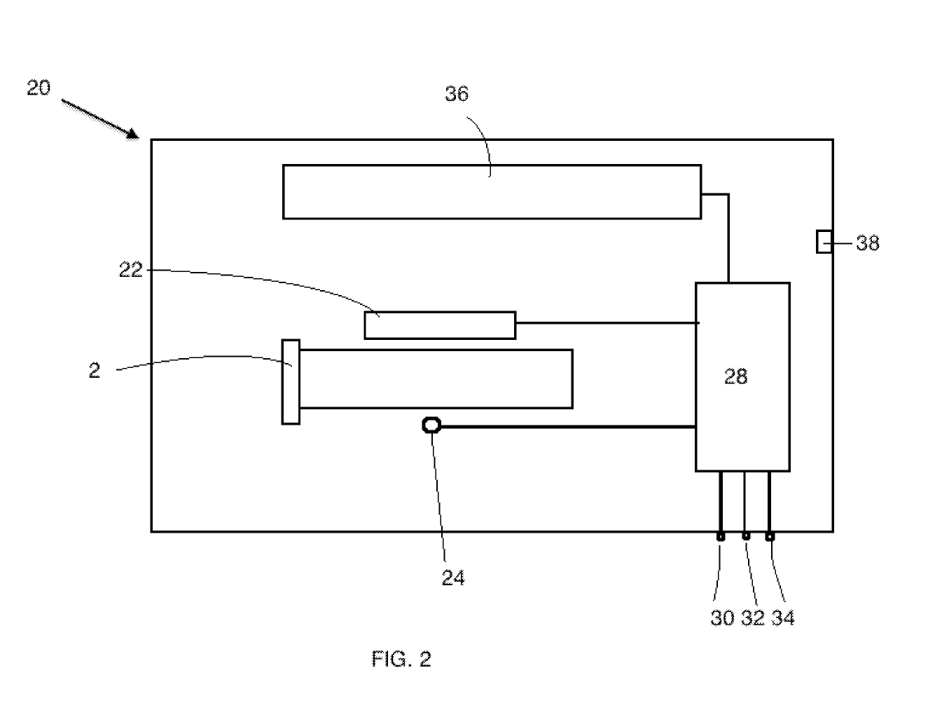

FIG. 3 is a chart illustrating an aspect of the invention.

### DESCRIPTION OF THE PREFERRED EMBODIMENTS

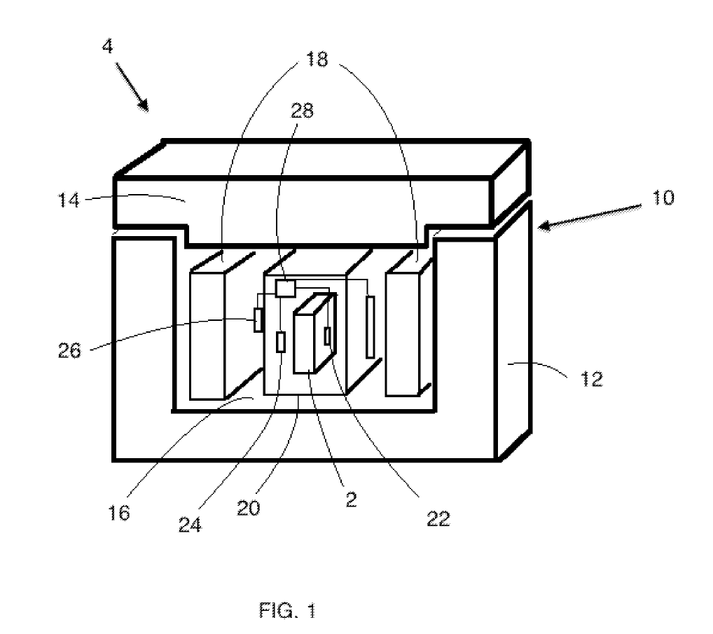

Referring now to the drawings, the device for thermally controlling, preserving and safely transporting a specimen 2 of the instant invention is generally designated by the number 4. Such specimen 2 is by way of example, a biological specimen, semen. As shown in FIG. 1, a container 10 for cooling, preserving and transporting semen specimen 2 includes a thermally insulated housing 12 and lid 14 which can be made of a polystyrene or other foamed material. The housing 12 and lid 14 defining an interior zone 16 for receiving other components of the invention.

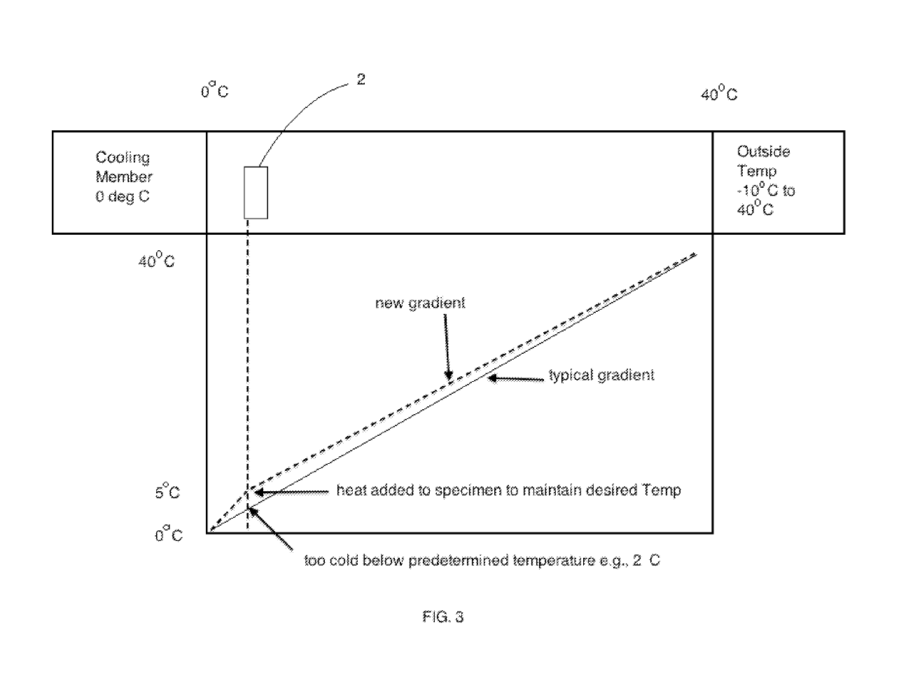

Specifically, there is provided one or more cooling members 18 disposed within the interior zone 16 of the container 10. An inner compartment 20 can is disposed within the interior zone 16 of the container 10 for receiving the specimen 2 which therein is in spaced relation to the cooling members 18. The cooling members 18 can include one or more ice or gel packs, for example. It is contemplated that other cooling devices can be employed such as refrigerants, but that gel packs are suitable for most purposes. The cooling member 18 is configured to cool the space surrounding the inner compartment 20 and specimen 2 therein below a desired predetermined shipping temperature, or below the optimum temperature for preserving the viability of the specimen 2, e.g., below 5° C. This is illustrated in FIG. 3.

The device 4 further includes a heating member 22, such as a resistor, operably disposed within the inner compartment 20 for applying heat within the specimen 2 to raise and maintain temperature therein at the desired shipping temperature of about 5° C. A temperature sensor 24 is operably disposed within the inner compartment 20 for sensing the temperature therein and specimen 2. Another temperature sensor 26 can be operably disposed within the container 10 for sensing the temperature of in the interior zone 16 adjacent the cooling members 18.

A controller, such as a microprocessor, 28 can be operably connected to the temperature sensors 24 and 26 and the heating member 22. The device 4 can include one or more diagnostic LEDs 30, 32 and 34 connected thereto. Such LEDs can include an error LED 30, temperature indicator LED 32, cooling temperature LED 34. The microprocessor 28 includes memory and software for obtaining sensed temperature and controlling rate of cooling of the specimen according to a predetermined set of parameters for the specimen and further for obtaining the sensed temperatures and repeatedly controlling the rate of cooling of the specimen 2 once a variation has occurred. It is contemplated that the controller 28 can include a preset thermostat with bimetallic strip or comparator with thermistor. A power source 36, such as a battery, is operably connected to the microprocessor 28 for enabling operation of the microprocessor 28 and controlling operation of the resistor 22 and LEDs 30, 32 and 34. An on/off switch 38 is operably connected to the microprocessor 28. The memory and software are equipped to store specimen time and temperature information, as well as environment and cooling member temperatures. This data can be retrieved with a computer employing a small lcd screen.

Temperatures outside the shipping container can typically vary from −10° C. to 40° C. The cooling members 18 can preferably cool to 0° C. Temperature can be elevated and maintained by employing the heating member 22 to a predetermined around 5° C., e.g. Accordingly, the instant invention provides for shipping chilled semen at a consistently maintained temperature and can accommodate for significant temperature changes which occur during inspection and transport.

The invention enables a rate of cooling of the specimen 2 is an optimum rate. The invention brings the specimen 2 to the desired shipping temperature, e.g. 5° C. at a controlled rate and maintains it. As the cooling members drop temperature to about 18 degrees, the rate of cooling is controlled by the microprocessor 22 employing the necessary amount of heat by way of resistor 22 to about one degree Centigrade every 20 minutes, for example, until the optimum temperature is reached. This is significant because if it cools to quickly, the specimen 2 will be jeopardized.

The specimen 2 can be disposed within a vial, tube or other conventional collection device (syringe) and placed within the inner compartment 20. The inner compartment 20 can be equipped with internal chambers for receiving positionally maintaining each of the specimen 2, microprocessor 28, heating member 22, sensor 24, and power source 36. The inner compartment 20 can also be fitted with positioning material to maintain the specimen 2 and other components in relatively fixed position.

The use of the container 4 begins immediately after collection of a specimen 2, such as extraction of semen from an animal. After specimen collection, the semen is placed in a suitable tube and loaded into a chamber within the inner compartment 20. The container 4 is loaded with a cooling members 18 adjacent the inner compartment 20. The switch 38 is turned on and the microprocessor 28 controls the cool down process in accordance with software thereon using sensors 24 and 26 and heating member 22. The specimen 2 starts to cool when loaded into the container 4 at a decrease rate of about two minutes per degree Centigrade until it reaches about 18 degrees and then the microprocessor 28 slows the cooling process to about 1 degree Centigrade every 20 minutes using heating element 22 to assure temperature does not drop too rapidly or below that needed for preserving the specimen 2.

Modifications of the embodiments described above, which are only illustrative other than those already suggested, may be made by those skilled in the art without however departing from the spirit and scope of the invention, as set forth in the following claims.

What is claimed is:

1. A device for thermally controlling, preserving and safely transporting specimens, which includes:
a container having a housing and a lid;
an inner compartment having a specimen area therein for containing a specimen within a specimen compartment within said container;
at least one cooling member disposed within said housing adjacent said inner compartment and configured to cool area surrounding said inner compartment below a desired predetermined temperature for the specimen;
a first temperature sensor is operably disposed within said inner compartment for sensing the temperature therein;
a heating member operably disposed within said inner compartment for applying heat within the inner compartment;
a power source; and
a controller operably connected to said power source and said temperature sensor to control and maintain temperature in said inner compartment to preserve the specimen.

2. The device of claim 1, which further includes a second temperature sensor be operably disposed within said container for sensing the temperature within said housing adjacent said cooling member.

3. The device of claim 1, which further includes at least one diagnostic LED operably connected to said microprocessor.

4. The device of claim 3, which is further characterized to include at least one of an error LED, a temperature indicator LED, and a cooling temperature LED.

5. The device of claim 1, wherein said controller includes a microprocessor includes memory and software for obtaining sensed temperature and controlling rate of temperature change of the specimen area according to a predetermined set of parameters for the specimen.

6. The device of claim 1, wherein said power source includes a battery.

7. The device of claim 1, wherein the cooling member includes one of an ice pack and a gel pack.

8. The device of claim 1, wherein said cooling member are in spaced relation to the specimen area.

9. The device of claim 1, wherein said housing and said lid are made of a thermally insulating material for thermally insulating said specimen area contained therein from the ambient temperature surrounding said container.

10. The device of claim 1, wherein said specimen area in said inner compartment can further include an insulated chamber to house the specimen therein.

11. The device of claim 1, wherein said heating member can includes a resistor.

12. The device of claim 1, wherein said controller includes a preset thermostat.

13. A method of the invention, for cooling, preserving and safely transporting a specimen, which includes the steps of:
(a) providing an insulating container;
(b) providing in the container at least one cooling member, at a temperature below the optimum temperature for preserving the specimen;
(c) providing into an inner compartment in the container a specimen container for receiving a specimen,
(d) providing a heating member within the inner compartment to enable heat to the specimen; and
(e) providing a processor for controlling application of heat to the specimen to maintain temperature of the specimen at the optimum temperature for preserving the specimen.
